(19) United States
(12) Patent Application Publication
(10) Pub. No.: US 2007/0002295 A1
(43) Pub. Date: Jan. 4, 2007

(54) System and method of monitoring and diagnosing system condition and performance

(75) Inventors: Maria Elisabeth Reuhman-Huisken, Waalre (NL); Leon Martin Levasier, Hedel (NL); Tasja Van Rhee, Rosmalen (NL); Rosaria Salpietro, Eindhoven (NL); Erik Johannes Schoemaker, Veldhoven (NL); Eric Jacqmin, Eindhoven (NL); Martin Prins, Dommelen (NL); Marcel Nicolaas Jacobus Van Kervinck, Eindhoven (NL); Timotheus Marc Vincent Bootsma, Eindhoven (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 11/170,739

(22) Filed: Jun. 30, 2005

(51) Int. Cl. G03B 27/42

(52) U.S. Cl. 355/53; 355/55

(57) ABSTRACT

The invention is directed to a system and method of monitoring and/or diagnosing tool performance in real-time for system degradation. The invention issues alerts and provides a structured process for identifying the source of the problem and enabling action to be taken before defects are detected on the final product. The invention provides a hierarchical data structure including elements that are monitored based on key performance indicators and diagnostic data sets.

### BACKGROUND

1. Field of the Invention

This invention relates to systems and methods of monitoring and diagnosing functional and/or performance aspects of operations.

2. Background Information

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. including part of, one, or several dies) of a substrate (e.g. a silicon wafer or other wafer). The pattern is typically transferred via imaging onto a layer of radiation-sensitive material (resist) provided on the substrate.

In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the radiation beam through a pattern in a given direction (the “scanning”-direction), while synchronously scanning the substrate in a direction that is parallel or anti-parallel to this direction. It is also possible to transfer the pattern from the patterning device to the substrate by imprinting the pattern onto the substrate.

A factory in which semiconductor devices are manufactured is commonly referred to as a “fab” or “foundry” and may include lithographic processing machines (or “lithomachines”). Each lithomachine may stand alone or be grouped with devices including track tools that apply resist layers to substrates and develops the exposed resist, metrology tools, inspection tools, wafer handling devices, and other pre- and post-processing devices to form a lithographic processing system commonly called a lithographic processing cell or “lithocell.” Both the lithomachines and devices may include supervisory control systems that are themselves under the control of a further supervisory control system.

The lithomachines may include two or more substrate tables (and/or two or more mask tables). In these multistage devices, the additional tables may be used in parallel, or preparatory steps may be carried out on one or more tables while one or more other tables are being used for exposures.

The lithomachines also may include substrates that are immersed in a liquid having a relatively high refractive index (e.g., water) so as to fill a space between an element of the projection system and the substrate. Immersion liquids may also be applied to other spaces in the lithomachines, for example, between a mask and an element of the projection system. Using immersion techniques increases an effective numerical aperture of projection systems, as known in the art.

Typically, devices on substrates are manufactured in the lithocell by a sequence of lithographic processing steps. The devices undergo several processing steps on different lithomachines. Between one layer and the next overlapping layer, the individual patterns of the one layer and the next overlapping layer are aligned. A measure for the alignment is obtained by an overlay metrology tool that utilizes marker structures. One example for determining overlay is the box-in-box overlay measurement technique.

In known systems, performance failure and/or degradation are detected by measuring product wafers or monitor wafers after completion of processing steps. These measurements are typically performed by off-line tools. If a defect is detected, an alert may be issued prompting the need to make adjustments to the lithocell. However, identifying problems after detecting performance failure and/or degradation does not allow preventative measures to be taken.

The lithocell is typically an integration of many sub-systems, each performing functions in creating an IC. Waiting until completion of processing steps to measure product wafers or monitor wafers for performance failure and/or degradation may not provide sufficient information to determine a source of the failure. Diagnosing failure is complex at least because cause and effect are not one-to-one related.

In order to identify a cause of the performance failure and/or degradation, large amounts of data associated with the corresponding lithocell are analyzed after the fact. This analysis is not efficient and may consume a considerable amount of time, especially when all potential causes are explored in a pre-selected order, without the benefit of targeted problem-solving techniques. Various other drawbacks exist.

Known methods of waiting until completion of processing steps to measure product wafers or monitor wafers for performance failure and/or degradation are also deficient because they do not enable monitoring of devices for performance failures and/or degradations by detecting drifts and/or failure modes at an early stage. Rather, known methods detect performance failures and/or degradations after they have occurred. Various other drawbacks exist.

In other known systems, monitoring techniques are provided for tracking individual sensor readings in order to indicate or anticipate failure of a specific part of the lithocell. However, the lithocell may deliver defective product wafers or monitor wafers at the end of processing steps even if one or more individual sensor readings are determined to be within an acceptable working range. The defective wafers may result from an actual performance of sensor/actuator systems, wherein the performance is acceptable in isolation but unacceptable when coupled to other sensor/actuator systems. Various other drawbacks exist.

Other drawbacks exist with these and other conventional systems.

### SUMMARY

Various aspects of the invention overcome at least some of these and other drawbacks of existing systems. According to one embodiment of the invention, the mean time to repair (MTTR) may be improved by providing system performance information. For example, system performance degradation may be correlated with regions of the lithocell that have experienced changes, as measured using performance indicators. By associating system performance degradation to targeted regions of the lithocell, time may be saved during fault determination analysis.

According to one embodiment of the invention, sensing devices may be placed at various locations throughout the lithocell to gather data. The data may be gathered during system operation and/or at other times. The data may be logged, organized and/or otherwise manipulated. In one exemplary embodiment, the data may be organized in a hierarchical order, wherein levels, entries and other components of the hierarchy may correspond to functions that are performed during system operation. In one exemplary embodiment of the invention, the hierarchical layout may reflect a process sequence of the lithocell.

According to another embodiment of the invention, upper levels of the hierarchy may correspond to high order functions of the system including, for example, imaging, overlay, productivity and other high order functions. Lower levels of the hierarchy may correspond to low order functions of the system including, for example, sub-functions associated with the high order functions. The functions may represent system operations that are reported as either operating or not operating.

According to one embodiment of the invention, the hierarchy may include performance information that provides qualitative measurements of how well the functions are performing. Thus, the hierarchy may provide both functional information and performance information.

According to another embodiment of the invention, the performance information may be presented as raw data and/or as quantified data. The raw data is hereinafter called diagnostic data sets. The quantified data is hereinafter called key performance indicators. According to one embodiment of the invention, one or more key performance indicators may be associated with functions of the system. Additionally, to save time and cost, key performance indicators may be defined for data that corresponds to upper levels of the hierarchy, while the remaining data may be presented as diagnostic data sets.

According to one embodiment of the invention, the key performance indicators may include a range of acceptable values (i.e., norms) or other metrics that are determined for data received from the sensing devices. The key performance indicators typically are determined for data that corresponds to upper levels of the hierarchy. In contrast, the diagnostic data sets typically are maintained for data that corresponds to lower levels of the hierarchy.

According to another embodiment of the invention, key performance indicators may be used to monitor and/or diagnose tool performance. Upon detection of a performance deviation, the key performance indicators may be used to efficiently isolate causes and/or sources of performance deviations and may enable a problem source to be repaired as fast as possible.

According to one embodiment of the invention, a combination of functional information and performance information may be used to provide a starting point within the hierarchy for locating the problem source. For example, upon detecting that functions within the process sequence are not working properly, key performance indicators that correspond to these problematic functions may be analyzed to determine whether or not the key performance indicators are within a range of acceptable values. Upon detecting one or more key performance indicators that are outside a range of acceptable values, the failure analysis may begin in the hierarchical structure at the highest level key performance indicator that is outside of the range and may proceed with navigating the hierarchical structure toward associated lower level key performance indicators. As navigation continues down the hierarchical structure, the key performance indicators may identify diagnostic data sets that may be analyzed to identify a root cause of the failure. Additionally, the key performance indicators and/or the diagnostic data sets may provide insight for conducting further testing to obtain relevant data. In this way, the hierarchical structure provides guidance for determining the cause of a failure. In an alternative embodiment, the hierarchical structure may be navigated from a lower portion to an upper portion along related key performance indicators. Additionally, the hierarchical structure may be navigated by moving both up and down along related key performance indicators.

These and other objects, features, and advantages of the invention will be apparent through the detailed description of the embodiments and the drawings attached hereto. It is also to be understood that both the foregoing general description and the following detailed description are exemplary and not restrictive of the scope of the invention. Numerous other objects, features, and advantages of the invention should now become apparent upon a reading of the following detailed description when taken in conjunction with the accompanying drawings, a brief description of which is included below. Where applicable, same features will be identified with the same reference numbers throughout the various drawings.

### BRIEF DESCRIPTION OF THE DRAWINGS

FIG. 1 illustrates a lithographic apparatus according to one embodiment of the invention.

FIG. 2 illustrates a system hierarchy according to one embodiment of the invention.

FIG. 3 illustrates a performance hierarchy for an imaging function according to one embodiment of the invention.

FIG. 4 illustrates a performance hierarchy for an overlay function according to one embodiment of the invention.

FIG. 5 illustrates a functional hierarchy for an alignment subsystem according to one embodiment of the invention.

FIG. 6 illustrates a navigation structure according to one embodiment of the invention.

FIG. 7 illustrates time-based graphs according to one embodiment of the invention.

### DETAILED DESCRIPTION

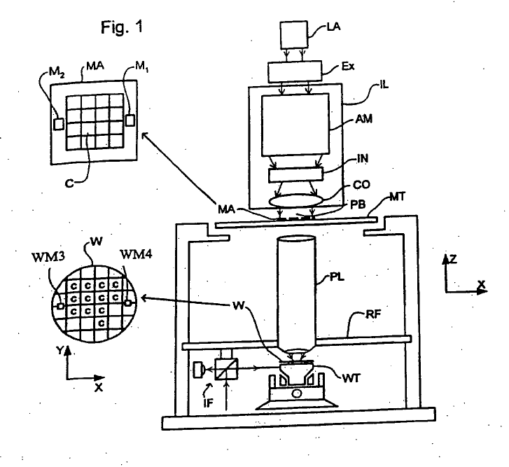

FIG. 1 schematically depicts a lithographic apparatus according to a particular embodiment of the invention. The apparatus includes an illumination system (illuminator) IL for providing a projection beam PB of radiation (e.g. UV radiation or DUV radiation); a first support structure (e.g. a mask table) MT for supporting patterning structure (e.g. a mask) MA and connected to first positioner PM for accurately positioning the patterning structure with respect to item PL; a substrate table (e.g. a wafer table) WT for holding a substrate (e.g. a resist-coated wafer) W and connected to second positioner PW for accurately positioning the substrate with respect to item PL; and a projection system (e.g. a refractive projection lens) PL mounted on a frame F and configured to image a pattern imparted to the projection beam PB by patterning structure MA onto a target portion C (e.g. comprising one or more dies) of the substrate W.

As here depicted, the apparatus is of a transmissive type (e.g. employing a transmissive mask). Alternatively, the apparatus may be of a reflective type (e.g. employing a programmable mirror array of a type as referred to above).

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases, the source may be an integral part of the apparatus, for example when the source is a mercury lamp. The source SO and the illuminator IL, together with the beam delivery system BD if used, may be referred to as a radiation system.

The illuminator IL may include an adjuster AM for adjusting the angular intensity distribution of the beam. Generally, at least the outer and/or inner radial extent (commonly referred to as -outer and -inner, respectively) of the intensity distribution in a pupil plane of the illuminator can be adjusted. In addition, the illuminator IL generally includes various other components, such as an integrator IN and a condenser CO. The illuminator provides a conditioned beam of radiation, referred to as the projection beam PB, having a desired uniformity and intensity distribution in its cross-section.

The projection beam PB is incident on the mask MA, which is held on the mask table MT. Having traversed the mask MA, the projection beam PB passes through the lens PL, which focuses the beam onto a target portion C of the substrate W. With the aid of the second positioner PW and position sensor IF (e.g. an interferometric device), the substrate table WT can be moved accurately, e.g., so as to position different target portions C in the path of the beam PB. Similarly, the first positioner PM and another position sensor (which is not explicitly depicted in FIG. 1) can be used to accurately position the mask MA with respect to the path of the beam PB, e.g., after mechanical retrieval from a mask library, or during a scan. In general, movement of the object tables MT and WT may be realized with the aid of a long-stroke module (coarse positioning) and a short-stroke module (fine positioning), which form part of the positioner PM and PW. However, in the case of a stepper (as opposed to a scanner), the mask table MT may be connected to a short stroke actuator only, or may be fixed. Mask MA and substrate W may be aligned using mask alignment marks M1, M2 and substrate alignment marks P1, P2.

The depicted apparatus can be used in the following preferred modes:

1. In step mode, the mask table MT and the substrate table WT are kept essentially stationary, while an entire pattern imparted to the projection beam is projected onto a target portion C in one action (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the projection beam is projected onto a target portion C (i.e. a single dynamic exposure). The velocity and direction of the substrate table WT relative to the mask table MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning structure, and the substrate table WT is moved or scanned while a pattern imparted to the projection beam is projected onto a target portion C. In this mode, generally a pulsed radiation source is employed and the programmable patterning structure is updated as required after each movement of the substrate table WT or in between successive radiation pulses during a scan. This mode of operation can be readily applied to maskless lithography that utilizes programmable patterning structure, such as a programmable mirror array of a type as referred to above.

Combinations and/or variations on the above described modes of use or entirely different modes of use may also be employed.

Systems are known that, upon completion of a process, monitor the manufactured products and provide alerts when failures are detected on the manufactured products. The invention provides system monitoring and/or diagnosing that enables real-time measurement of system performance degradation so that alerts may be issued and actions may be taken to correct performance degradation before a failure is detected on a manufactured product. In one embodiment of the invention, system monitoring and/or diagnosing may be performed using functional information and/or performance information.

The functional information gathering and/or performance information gathering may be performed in-line, on-line, off-line, or a combination of in-line, on-line, off-line, among other techniques. In-line information gathering may occur while the system is performing normal production activities so that normal production sequences are not interrupted. On-line information gathering may be performed at scheduled intervals when normal production sequences are interrupted. In one exemplary embodiment of the invention, on-line information gathering may be scheduled between lots, among other times. Off-line information gathering may be performed manually, or at scheduled intervals, when normal production sequences are interrupted and when measurements are performed on substrates or other materials. According to one exemplary embodiment of the invention, data gathering is first obtained using in-line information, then on-line information, and lastly off-line. Other sequences for data gathering are contemplated.

Functional information and/or performance information may be captured according to various intervals. According to one embodiment of the invention, data gathering intervals may include time-based intervals such as fixed predetermined frequencies, such as every hour, minute, second, fraction of a second or other time-based intervals. Alternatively, the data gathering intervals may include other than time-based intervals, such as die/wafer/reticle/image/lot-based intervals, among other non time-based intervals. The data may be gathered continuously or intermittently. One of ordinary skill in the art will readily appreciate that a combination of time-based/non time-based intervals may be utilized to gather data.

Functional information and/or performance information may be gathered using sensors, actuator systems, and other sensing devices. The sensing devices may be distributed throughout lithomachines and may provide information regarding trends, drifts, ambient air and other information corresponding to operational aspects of lithomachine components. According to one embodiment of the invention, the sensing devices may generate a large amount of data during system operation. Without an organized procedure and/or automated routine in place for processing and/or analyzing the large amount of data, several hours of troubleshooting may be invested before the cause of the problem is determined.

In order to streamline the troubleshooting process, the data may be organized into various diagnostic data sets that correspond to one or more functions and/or sub-functions performed during system operation. The diagnostic data sets may include raw data associated with the lithomachines, among other information. For example, the diagnostic data sets may include temperature readings, pressure readings, light intensity readings, and other diagnostic data set information. The diagnostic data sets may be organized by function or other category. The diagnostic data sets may be analyzed in real-time and/or stored for subsequent processing.

According to one embodiment of the invention, patterns may be discovered between variations in selected diagnostic data sets and deviations in system performance functions. In order to further streamline the troubleshooting process, a range of metrics may be defined for the diagnostic data sets that corresponds to acceptable/unacceptable operational conditions for the lithomachines. The diagnostic data sets having the associated range of metrics are hereinafter called key performance indicators.

According to another embodiment of the invention, the key performance indicators may include a range of operational values that correspond to good system operation, wherein the range is bounded by upper and lower values. The key performance indicators may correspond to functions that are performed within a process sequence. Thus, if a function is determined to be operating improperly, one or more key performance indicators associated with the function may be identified to begin searching for a cause of the performance deviation. One of ordinary skill in the art will readily appreciate that other system operation identifiers may be used.

According to one embodiment of the invention, the functions, key performance indicators, diagnostic data sets, and other elements may be organized and presented according to numerous configurations. In one embodiment, a hierarchical configuration may be used to present the information. Other configurations may be used to present the elements.

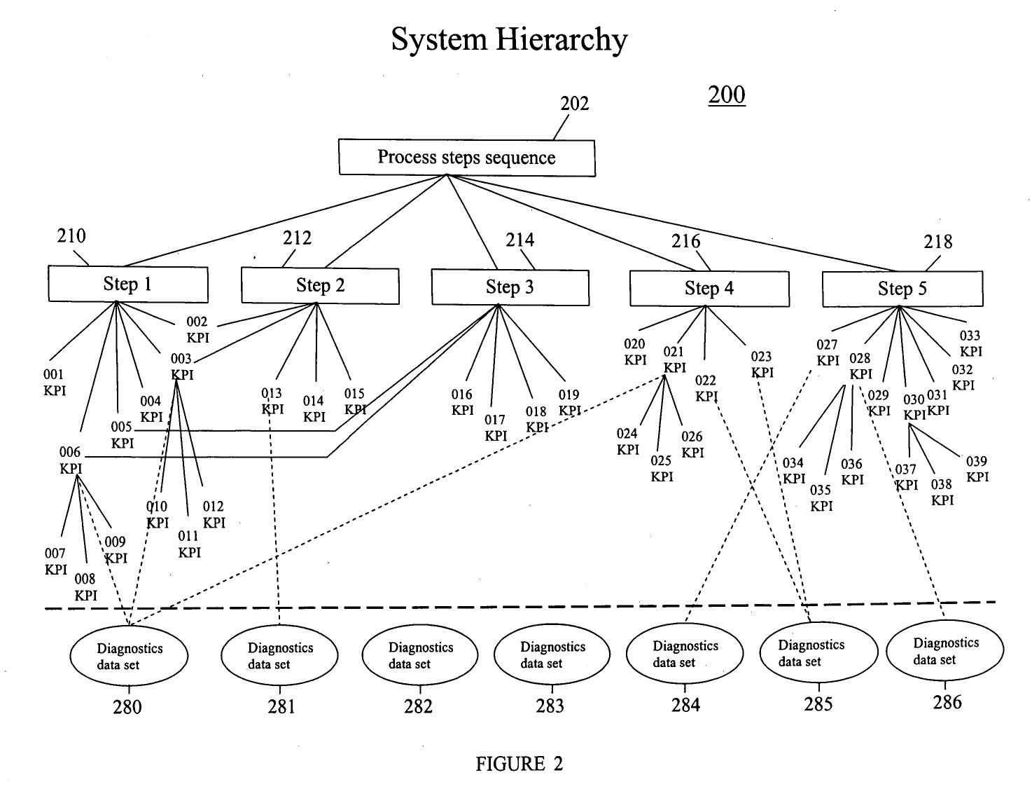

The hierarchical configuration may include one or more elements that represent system components, functions that are implemented to achieve an end performance (i.e., imaging, overlay, productivity and other functions), key performance indicators, diagnostic data sets and other elements. FIG. 2 illustrates one exemplary embodiment of the invention having system hierarchy 200 that includes the functional information and/or the performance information organized according to a sequence of process steps that are performed during system operation. The system hierarchy 200 may include multiple levels, entries and other components that correspond to functions that are performed during system operation. The invention contemplates using alternative element configurations, a greater number or a fewer number of elements, and other variations. The invention also contemplates illustrating a plurality of relationships between elements of the hierarchical structure. Other configurations may be used to organize the functional information and/or the performance information.

According to one embodiment of the invention illustrated in FIG. 2, the sequence of process steps 202 may include several steps 210-218 that correspond to functions that are performed during system operation. In one exemplary embodiment, the steps may correspond to a first step 210 that includes stage alignment, a second step 212 that includes global level contouring, a third step 214 that includes a wafer map, a fourth step 216 that includes an execution of exposure that uses the wafer map, and so on. One of ordinary skill in the art will readily appreciate that other steps may be employed during system operation.

According to another embodiment of the invention, upper levels of the hierarchy may correspond to high order functions of the system, while lower levels of the hierarchy may correspond to lower order functions or sub-functions of the system. Several levels of elements may be provided between the upper levels of the hierarchy and the lower levels of the hierarchy.

According to one exemplary embodiment of the invention, the system hierarchy 200 may be generated by determining a functional breakdown of the system and identifying corresponding sensing devices or data sources that may be used to monitor and/or validate aspects of the functions, or steps that are performed within the functions. In one exemplary embodiment, upper levels of hierarchy 210-218 represent main system functions. Sub function may be derived from the main system functions and may be placed in lower levels of the hierarchy. Diagnostic data sets 280-286 may be obtained from the sensing devices or data sources and may be associated with the corresponding functions and/or steps. According to one exemplary embodiment, diagnostic data sets may be provided with a range of metrics and may be converted to key performance indicators. In one embodiment, hierarchy 200 may include two or more levels of key performance indicators and/or diagnostic data sets that are linked through other key performance indicators and/or diagnostic data sets. Additionally, two or more functions 210-218 may share two or more key performance indicators 001KPI-039KPI. For example, first step 210 and second step 212 share 002KPI and 003KPI at a same level and 010KPI-012KPI at a different level that is similar for first step 210 and second step 212.

The inclusion of key performance indicators 001KPI-039KPI in the hierarchy enables active monitoring of system performance and increases diagnostic speeds by actively detecting when measured values drift outside normal ranges, among providing other benefits. In contrast to key performance indicators 001KPI-039KPI, diagnostic data sets 280-286 enable passive monitoring of system performance and provide raw data that may enable data analyzers to identify a root cause of a system deviation. According to one embodiment of the invention, diagnostic data sets 280-286 may be included at lower levels in the hierarchy to enable a detailed analysis of system operations after identification of a system deviation using upper level elements. While including key performance indicators 001KPI-039KPI in the hierarchy promotes active system monitoring and increases diagnostic speeds, a tradeoff exists between the benefits of increased automation and expending time and resources to determine metrics for the diagnostic data sets. According to an exemplary embodiment of the invention, selected data generated by the detecting devices is stored in diagnostic data sets. A portion of the diagnostic data sets are converted to key performance indicators.

According to one exemplary embodiment of the invention, upon detection of a performance deviation at an upper level function 210-218 of the hierarchy, one or more associated key performance indicators 001KPI-039KPI may be identified as having measured values outside normal ranges. An upper level key performance indicator of the hierarchy may be identified and the hierarchy may be navigated to lower levels until a root cause is determined. The root cause may be identified through analysis of lower level key performance indicators and/or diagnostic data sets. By navigating the hierarchy in a top-down fashion, a focused approach may be provided to locate one or more causes of the deviation.

In situations where more than one level of the hierarchy shows a source of performance deviation, the relevance of the element in the hierarchical structure may be determined based on the location of the level within the hierarchy. According to one embodiment of the invention, a problem that is identified at an upper level element may take precedence over a problem that is identified at an unrelated lower level element. Other techniques may be employed for assessing the relative importance of problems that are identified through one or more levels of the hierarchical structure.

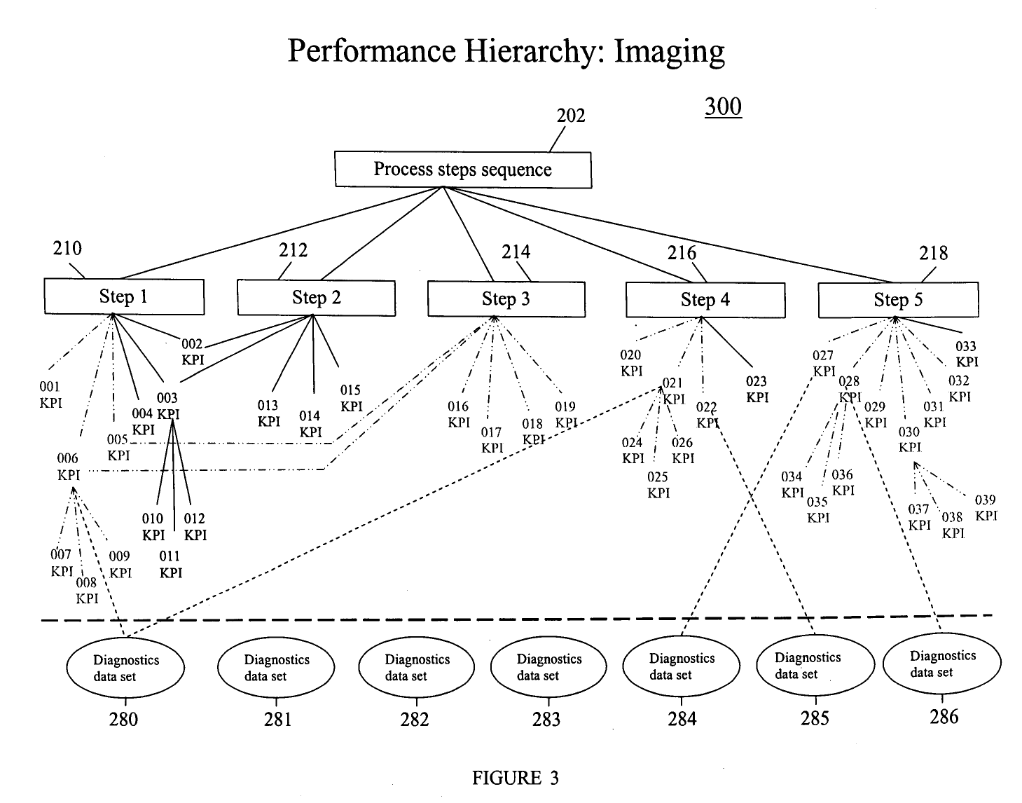

FIG. 3 illustrates an exemplary embodiment of a performance hierarchy 300 for an imaging function of a lithocell. The imaging function is associated with first step 210, third step 214, fourth step 216 and fifth step 218. According to one embodiment of the invention, the imaging function is associated with the key performance indicators that are linked through the line configured with a dash followed by two dots. In one embodiment, the imaging function is associated with first step 210, key performance indicators 001KPI, 005KPI, 006KPI-009KPI, and diagnostic data set 280. In another embodiment, the imaging function is associated with third step 214 and key performance indicators 005KPI, 006KPI-009KPI, 016KPI-019KPI. In yet another embodiment, the imaging function is associated with fourth step 216, key performance indicators 020KPI-022KPI and 024KPI-026KPI and diagnostic data sets 280, 285. In yet another embodiment, the imaging function is associated with fifth step 218, key performance indicators 027KPI-032KPI, 034KPI-039KPI and diagnostic data sets 284, 286. The performance hierarchy may be navigated up or down along the KPIs to determine a root cause of a problem. Additionally, the hierarchy may provide guidance on pulling information from other sensing devices to provide a complete set of relevant data.

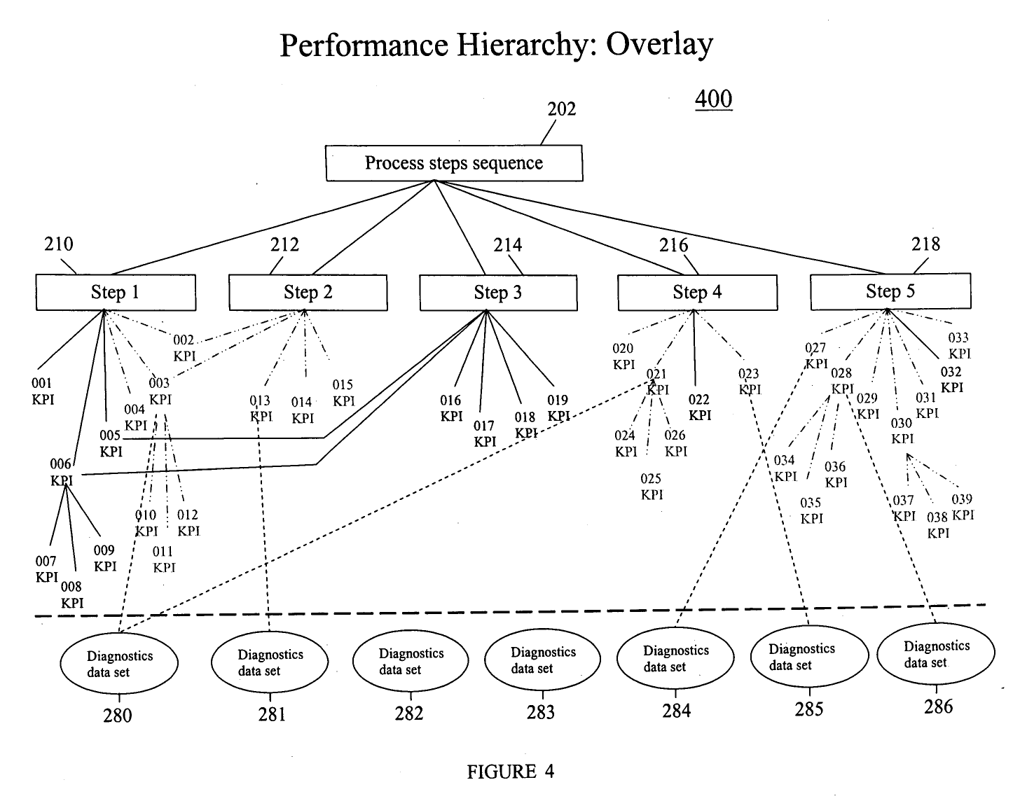

FIG. 4 illustrates an exemplary embodiment of a performance hierarchy 400 for an overlay function of a lithocell. The imaging function is associated with first step 210, second step 214, fourth step 216 and fifth step 218. According to one embodiment of the invention, the overlay function is associated with the key performance indicators that are linked through the line configured with a dash followed by two dots. In one embodiment, the overlay function is associated with first step 210, key performance indicators 002KPI-004KPI and 010KPI-012KPI, and diagnostic data set 280. In another embodiment, the overlay function is associated with second step 214 and key performance indicators 002KPI-004KPI and 013KPI-015KPI. As noted from FIG. 4, 002KPI, 003KPI and 010KPI-012KPI are shared between first step 210 and second step 212. In yet another embodiment, the overlay function is associated with fourth step 216, key performance indicators 020KPI, 021KPI and 023KPI-026KPI and diagnostic data sets 280, 285. In yet another embodiment, the imaging function is associated with fifth step 218, key performance indicators 027KPI-031KPI, 033KPI-039KPI and diagnostic data sets 284, 286. The performance hierarchy may be navigated up or down along the KPIs to determine a root cause of a problem. Additionally, the hierarchy may provide guidance on pulling information from other sensing devices to provide a complete set of relevant data. Also, information from the hierarchy may support adding additional sensing devices and/or controls in the system, among other modifications.

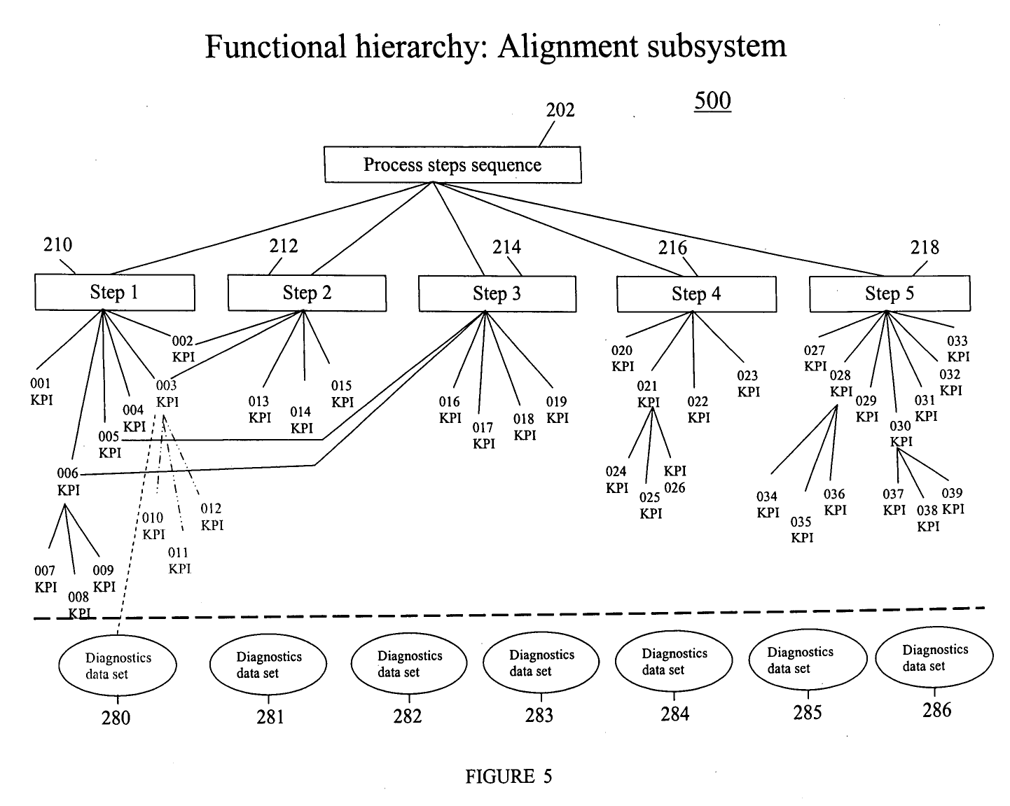

FIG. 5 illustrates an exemplary embodiment of a functional hierarchy 500 for an alignment subsystem of a lithocell. The alignment subsystem is associated with first step 210. According to one embodiment of the invention, the alignment subsystem is associated with the key performance indicators that are linked through the line configured with a dash followed by two dots. In one embodiment, the alignment subsystem is associated with first step 210, key performance indicators 003KPI and 010KPI-012KPI, and diagnostic data set 280. The performance hierarchy may be navigated up or down along the KPIs to determine a root cause of a problem. Additionally, the hierarchy may provide guidance on pulling information from other sensing devices to provide a complete set of relevant data.

According to one embodiment of the invention, the functional information may be navigated when error information is received indicating that a particular function of the system is not operating properly. The error information may be derived from expert knowledge, Problem, Cause and Solution (PCS) systems, error logs or other sources.

According to one embodiment of the invention, system performance degradation may be detected based on measurements taken at key performance indicators 001KPI-039KPI. Upon detection of system performance degradation, key performance indicators 001KPI-039KPI and/or diagnostic data sets 280-286 may be employed to isolate potential sources of the system performance degradation. Thus, information corresponding to key performance indicators 001KPI-039KPI and/or diagnostic data sets 280-286 may be employed to assist with troubleshooting, to provide trend analysis data, and to provide other diagnostic information. According to another embodiment of the invention, key performance indicators 001KPI-039KPI and/or diagnostic data sets 280-286 may be used to schedule preventative maintenance based on trend analysis information or other information.

Key performance indicators 001KPI-039KPI and/or diagnostic data sets 280-286 may be saved and stored for selected lengths of time to enable data processing, including tracking of performance, troubleshooting or other data processing. In one exemplary embodiment of the invention, key performance indicators 001KPI-039KPI and/or diagnostic data sets 280-286 may be stored for hours, days, weeks, months, years, and other lengths of time.

In one embodiment of the invention, information corresponding to key performance indicators 001KPI-039KPI and/or diagnostic data sets 280-286 may be used to schedule predictive maintenance that is based on measured performance degradation. In another embodiment of the invention, the predictive maintenance may be customized. For example, key performance indicator degradation may be correlated to product yield indicators that are measure inside and/or outside the litho system. The information derived from the correlation may be used to customize the predictive maintenance. One of ordinary skill in the art will readily appreciate that other information may be used to customize the predictive maintenance.

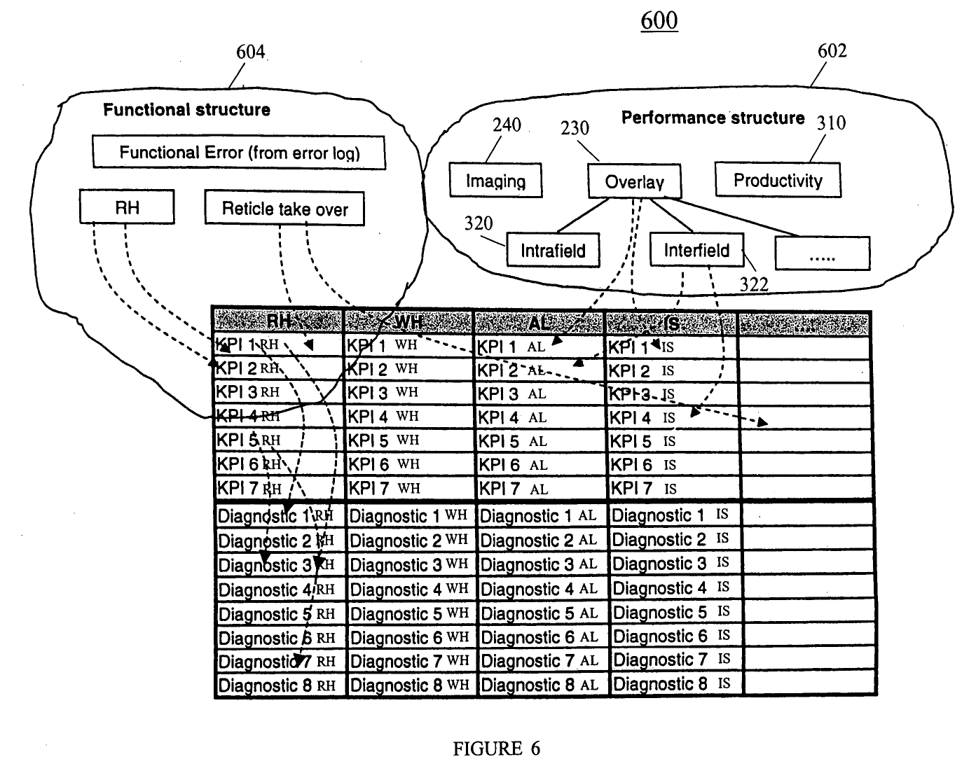

According to an alternative embodiment of the invention, FIG. 6 illustrates a hierarchical data model 600 that includes a functional structure 604 and performance structure 602. According to one embodiment of the invention, performance structure 602 includes performance-based hierarchical elements that may be navigated to troubleshoot degrading system performance. Performance-based hierarchical elements may include functions such as overlay 230, imaging 240, and productivity 310 at a first level. A second level originating from overlay 230 may include intrafield element 320 and interfield element 322, among other elements.

According to one embodiment of the invention, key performance indicators and/or diagnostic data sets may be selected to monitor a system based on an indication of degrading performance. The analysis may be conducted in a top-down order. In one exemplary embodiment, if an overlay problem is suspected, one or more of the overlay 230, the intrafield element 320 and the interfield element 322 may be selected for monitoring system performance. These performance driver elements may correspond to a upper layers of the evaluation process. At the next layer down, one or more key performance indicators (KPI 1RH-KPI 7RH, KPI 1WH-KPI 7WH, KPI 1AL-KPI 7AL, KPI 1IS-KPI 7IS) may be selected for monitoring based on a determined performance relationship to one or more of the overlay 230, the intrafield element 320 and the interfield element 322. At the next layer down, one or more diagnostic data sets (Diagnostic 1RH-Diagnostic 7RH, Diagnostic 1WH-Diagnostic 7WH, Diagnostic 1AL-Diagnostic 7AL, Diagnostic 1IS-Diagnostic 7IS) may be selected for monitoring based on a performance relationship to one or more key performance indicators. Since a system may include a plurality of key performance indicators, this top-down approach may focus the evaluation on a limited set of key performance indicators that are selected based on an increased probability of providing a targeted diagnostic assessment. In one embodiment, the system may include at least several hundred key performance indicators.

System monitoring and diagnostic assessments may reduce an average time needed to determine a cause of performance degradation so that the system or portion of the system may be efficiently adjusted back to acceptable operating conditions. As a result, the invention reduces the mean time to repair (MTTR) of a system. In an ideal case, system degradation may be identified and corrected before the system is determined to be faulty. Thus, the invention may eliminate and/or reduce the actual time needed to plan and arrange for spare systems, spare resources, and execution of tasks needed to restore the system back to operating conditions.

In an alternative embodiment of the invention, a bottom-up order may be used concurrently with or alternatively to the top-down order. In one exemplary embodiment, key performance indicators may be identified that indicate a performance aspect of a single component of the system. If a problem is suspected to exist with a single component of the system based on a diagnostic data set value (Diagnostic 1RH-Diagnostic 7RH, Diagnostic 1WH-Diagnostic 7WH, Diagnostic 1AL-Diagnostic 7AL, Diagnostic 1IS-Diagnostic 7IS), one or more diagnostic data sets may be selected to monitor performance of the system component. These diagnostic data sets may correspond to a bottom layer of the evaluation process. The diagnostic data sets may be linked to key performance indicators. At the next layer up, one or more key performance indicators (KPI 1RH-KPI 7RH, KPI 1WH-KPI 7WH, KPI 1AL-KPI 7AL, KPI 1IS-KPI 7IS) may be selected for monitoring based on a determined performance relationship to one or more diagnostic data sets. At the next layer up, one or more key performance indicators may be selected based on a performance relationship to other key performance indicators. Since hundreds of key performance indicators may be monitored to determine whether or not they are operating within predefined tolerance limits, this bottom-up approach may provide advance warning of potential system degradation before a system failure is detected. As more key performance indicators begin to fall outside predefined tolerance limits, there is an increased probability of predicting a system failure before the failure occurs.

According to one embodiment of the invention, a user interface may be provided that displays the hierarchical structure to enable users to efficiently navigate system data. Users may navigate the system data by traversing the hierarchical structure in a top-down and/or bottom-up fashion or by using other navigation techniques. In an alternative embodiment of the invention, the user interface may display several views including an events and history view, last changes view, general conditions view, recipe view, driver status view, material view, and other views.

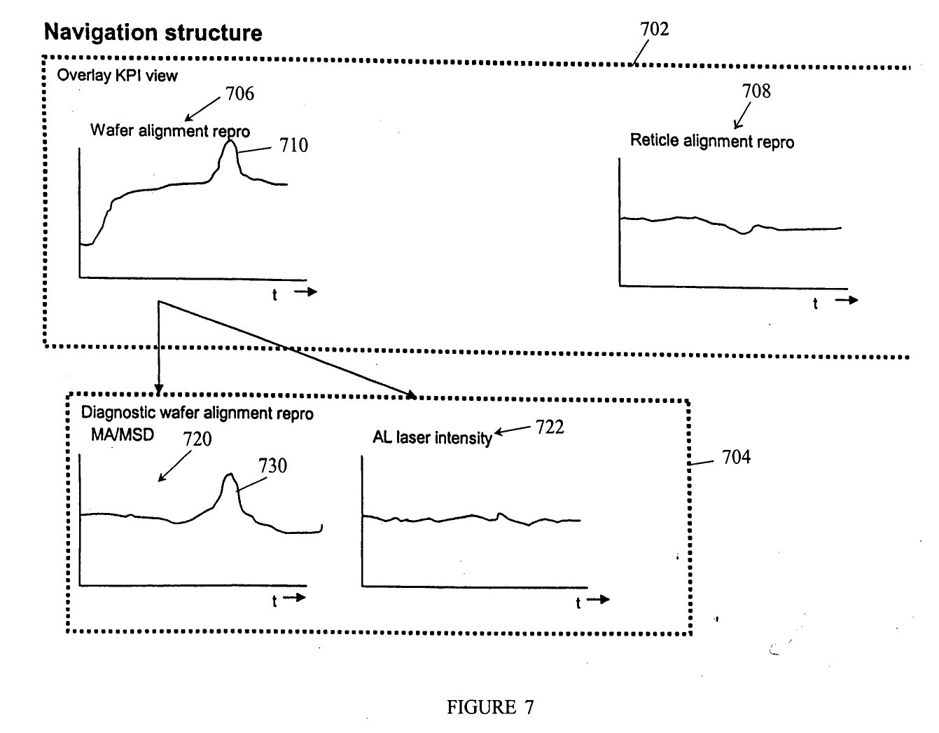

FIG. 7 illustrates a graphical representation of overlay key performance indicators 702 corresponding to wafer alignment reproduction 706 and reticle alignment reproduction 708, wherein the measurement is time-based. Wafer alignment reproduction 706 includes a high portion 710 that may correspond to system degradation of overlay 230. Also illustrated are graphical representations of diagnostic data sets 704 including MA/MSD 720 and AL laser intensity 722, which share a performance relationship to wafer alignment reproduction 706. MA/MSD 720 and AL laser intensity 722 are displayed as time-based measurements. MA/MSD 720 includes a high portion 730 that may indicate the source of high portion 710.

According to an one embodiment of the invention, the system may include two stages that enable a greater number of measurements on both wafers and the system without slowing down productivity of the system. These measurements may be obtained for selected lots, with the data being saved to long term storage for trend analysis. Data corresponding to key performance indicators that are associated with problem lots may be extracted from long term storage for comparison to normal values. A combined set of key performance indicators that are associated with lithomachines may be analyzed concurrently to determine a source of the problem within the lithomachine.

The invention provides at least the following benefits:

Increased performance diagnosis, in-line computation, and automated error determination that speeds up diagnosis, reduces human errors, and provides preventative measures, among various other benefits. The invention reduces demand for off-line error detection, such as measuring wafer features, to discover errors as they occur. A history of performance data may be created to enable system level condition monitoring and trend analysis, among other features.

The invention enables key performance indicators to be categorized based on their relevance to system performance. Priority may be assigned to data collection based on a level of the element in the hierarchy, a frequency with which the data is collected, or other factors. This enables diagnosis of a problem, location of an error within the correct subsystem level, and other actions to be performed in a structured way. Additionally, key performance indicators having suspect data readings may be identified, monitored, or inspected, among other actions.

The invention provides automated system monitoring so that significant portions of the system state may be reported on an on-going basis. This feature speeds up problem diagnosis and provides preventative maintenance information, among other benefits. Additionally, the invention enables performance diagnostics to be performed by users having minimal system knowledge because the system provides insight and guidance regarding problem areas. Furthermore, the invention provides the data and structure needed to perform remote diagnostics.

The invention enables the system to identify potential problems in real-time and enable preventative maintenance to be performed to maintain the final product within tolerance requirements. An alert may be generated and sent to communicate the potential problems. The alert may be sent via wireless or wired communication channels to any of a plurality of devices. The norms may be automatically fine-tuned to set active control limits for statistical process control (SPC) without needing users to collect and analyze trends of each performance indicator. Alternatively, the data may be analyzed by system users to monitor system conditions. Other techniques may be used to analyze the data.

According to one embodiment, the invention provides a navigation structure that guides troubleshooting in an efficient manner by monitoring changes in system behavior performance and tracing changes to variations in one or more system components. Alternatively, the invention may enable exclusion of a portion of the hierarchy from additional analysis due to acceptable readings for the key performance indicators. Furthermore, the invention may enable users to actively select systems for performing critical process steps or difficult applications based on information derived from the hierarchical structure.

The foregoing presentation of the described embodiments is provided to enable any person skilled in the art to make or use the invention. Various modifications to these embodiments are possible, and the generic principles presented herein may be applied to other embodiments as well. For example, the invention may be implemented in part or in whole as a hard-wired circuit, as a circuit configuration fabricated into an application-specific integrated circuit, as a firmware program loaded into non-volatile storage or a software program loaded from or into a data storage medium as machine-readable code, such code being instructions executable by an array of logic elements such as a microprocessor or other digital signal processing unit, or may include other implementations.

Embodiments of the invention include a computer program containing one or more sequences of machine-readable instructions describing a method as disclosed above, or a data storage medium (e.g. semiconductor memory, magnetic or optical disk) having such a computer program stored therein. The invention is not intended to be limited to the embodiments provided above, but rather is to be accorded the widest scope consistent with the principles and novel features disclosed in any fashion herein. The scope of the invention is to be determined solely by the appended claims.

What is claimed is:

1. A system for monitoring performance of lithographic machines, the system comprising:
a hierarchical data structure that includes elements;
a plurality of performance indicators that are associated with the elements to provide a measure of performance for corresponding elements;
diagnostic data sets that include raw data obtained from one or more sensing devices, wherein the diagnostic data sets are associated with corresponding elements; and
key performance indicators that are derived from diagnostic data sets and include predefined metrics, wherein the key performance indicators signal variations in lithographic machine performance when values measured from the sensing devices deviate from the predefined metrics.

2. The system according to claim 1, wherein the elements represent one or more functions or sub-functions performed during system operation.

3. The system according to claim 1, wherein condition monitoring of the lithographic machine is performed (i) on-line, (ii) off-line, (iii) in-line or any combination of (i)-(iii).

4. The system according to claim 1, further comprising a storage device that stores the data received from the plurality of sensing devices.

5. The system according to claim 4, wherein the data is stored according to predetermined intervals comprising (i) a time-based interval, (ii) a per die interval, (iii) a per wafer interval, (iv) a per image interval, (v) a per lot interval or (vi) any combination of (i)-(v).

6. The system according to claim 1, wherein the elements include at least one of imaging, overlay and productivity.

7. The system according to claim 1, further comprising a graphical user interface that displays the hierarchical data structure.

8. The system according to claim 7, wherein the elements and the associated performance indicators share relationships and wherein the graphical user interface is configured to graphically display the relationships.

9. The system according to claim 1, wherein the key performance indicators are associated with predefined limit values and wherein key performance indicators are identified if measured values fall outside the predefined limit values.

10. A method of monitoring performance of lithographic machines, the method comprising:
generating a hierarchical data structure that includes elements;
associating a plurality of performance indicators with the elements to provide a measure of performance for corresponding elements;
obtaining raw data from sensing devices distributed throughout the lithographic machines, wherein the raw data is organized as diagnostic data sets;
providing the diagnostic data sets with predefined metrics to create key performance indicators; and
generating an alert when measured values associated with the key performance indicators fall outside the predefined metrics, thereby signaling a variation in lithographic machine performance.

11. The method according to claim 10, wherein the elements represent one or more functions or sub-functions performed during system operation.

12. The method according to claim 10, further comprising performing condition monitoring of the lithographic machine (i) on-line, (ii) off-line (iii) in-line or any combination of (i)-(iii).

13. The method according to claim 10, further comprises storing the data received from the sensing devices.

14. The method according to claim 13, wherein the data is stored at predetermined intervals comprising (i) a time-based interval, (ii) a per die interval, (iii) a per wafer interval, (iv) a per image interval, (v) a per lot interval or (vi) any combination of (i)-(v).

15. The method according to claim 10, further comprising providing a graphical user interface that displays the hierarchical data structure.

16. The method according to claim 15, wherein the elements and the associated performance indicators share relationships and wherein the graphical user interface graphically display the relationships.

17. The method according to claim 10, further comprising associating the key performance indicators with predefined limit values and identifying the key performance indicators if measured values fall outside the predefined limit values.

18. The method according to claim 10, further comprising monitoring performance from a remote location.

19. The method according to claim 17, further comprising identifying the element that corresponds to the identified key performance indicator.

20. The method according to claim 19, further comprising sending the generated alert through a communication channel to a receiving device.

21. A method of monitoring performance of a lithographic machines, the method comprising:
generating a hierarchical data structure that includes elements;
associating a plurality of performance indicators with the elements to provide a measure of performance for corresponding elements;
defining predefined limit values for each of the plurality of performance indicators;
monitoring the plurality of performance indicators to determine if measured values fall outside the predefined limit values; and
determining the element that corresponds to the performance indicators that fall outside the predefined limit values.
